(19) United States
(12) Patent Application Publication
(10) Pub. No.: US 2006/0055965 A1
(43) Pub. Date: Mar. 16, 2006

(54) Image processing apparatus, program and recording medium

(76) Inventors: Hiroaki Nakamura, Ikoma-gun (JP); Tetsuya Shibata, Yawata-shi (JP)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 11/226,700

(22) Filed: Sep. 14, 2005

(30) Foreign Application Priority Data
Sep. 16, 2004 (JP) 2004-269207

(51) Int. Cl. G06F 3/12

(52) U.S. Cl. 358/1.15

(57) ABSTRACT

XML descriptive commands corresponding to an application of another device utilized on network can be easily generated. A digital multifunctional device is an embodiment of an image processing apparatus and is connected to network devices, such as a FAX server and a document server, via the network. The digital multifunctional device obtains a registered schema corresponding to an application of another network device such as a FAX server. When another network device is utilized, commands described in the XML is generated by using the obtained schema, and the commands are transmitted to appropriate network device along with image data to be processed. The network device receiving the image data and the commands executes predetermined processing in accordance with the commands.

### CROSS-NOTING PARAGRAPH

This non-provisional application claims priority under 35 U.S.C. §119 (a) on Patent Application No. 2004-269207 filed in JAPAN on Sep. 16, 2004, the entire contents of which are hereby incorporated herein by reference.

### FIELD OF THE INVENTION

The present invention relates to an image processing apparatus and, more particularly, relates to an image processing apparatus connected to network for transmitting image data via the network to other devices and utilizing applications of other devices to perform processing, and relates to a program achieving the functions of the apparatus, and recording medium.

### BACKGROUND OF THE INVENTION

Digital multifunctional devices (MFP (Multi Function Peripheral)) are in wide spread use, which are image processing apparatuses equipped with functions of copiers, printers, scanners, facsimile machines and the like. These digital multifunctional devices are typically connected to network and can utilize other devices by transmitting/receiving data to/from other devices via the network.

FIG. 1 is a diagram showing a typical configuration example of a digital multifunctional device. The digital multifunctional device 120 is configured as a multifunctional device equipped with a printer function, a scanner function, a copier function and the like, as described above.

A host I/F 121 is a connector for a communication interface of the digital multifunctional device 120 to transmit/receive data to/from a host (PC) 140 via USB or LAN. From the host 140, for example, print instructions can be input to the digital multifunctional device 120. An I/O controller 123 controls a data input/output between the host I/F 121 and a HDD 122. The HDD 122 is a recording medium for accumulating, for example, image data read out by the digital multifunctional device 120 and is also used for recording parameters for controls, communication parameters and the like.

A system controller 125 connects a CPU 126 to a system memory (RAM) 124 used as a memory area for control processing to perform main controls of the main unit of the digital multifunctional device, such as paper feeding, conveying, fixing, duplex printing and process controls in the digital multifunctional device.

An image controller 128 is connected with a main memory 129 having a page memory 129a, an image processing LSI 127 performing various types of image processing for image data, a scanner unit 130 equipped with an image readout function of a scanner device and a printer engine 131 for achieving a printer function, and performs image controls/scanner readout controls for the digital multifunctional device.

FIG. 2 is a diagram showing a configuration example of network to which the digital multifunctional device as described above is applied. In this diagram: 120 is the digital multifunctional device; 141 is a first FAX server; 142 is a second FAX server; 143 is a document server; and 150 is network such as a LAN. In the example of FIG. 2, the digital multifunctional device 120 is connected to the first and second FAX servers 141, 142 and the document server 143 via the network 150.

When using the digital multifunctional device 120 configured as above, if image data which are retrieved by the scanner unit of the digital multifunctional device 120 are transmitted to a server (in the example of FIG. 2, the first or second FAX server 141, 142, the document server 143 or the like) via the network to perform processing in that server, the digital multifunctional device 120 transmits, to the server, the image data as well as commands indicating what processing is wanted to be performed in the server. An application in the server performs predetermined processing for the image data in accordance with the transmitted commands.

As the processing, for example, in a FAX server, the transmitted image data are converted to FAX data and facsimiled; in a server with an OCR function, the transmitted image data are converted by the OCR function to text documents and transmitted back to the digital multifunctional device; or in a server with a function for annotation processing, annotations are added to the transmitted image data and the data are transmitted back to the digital multifunctional device.

In the processing as described above, if the digital multifunctional device utilizes the application of another device to perform processing, the application of the counterpart device can be utilized by transmitting commands as well as the image data to the application of the counterpart device.

As the command transmitted from the digital multifunctional device to another device as described above, commands written in XML are used. Currently, XML provides a language widely used in data exchange via network, and since tags can be set depending on applications such that the applications can interpret the tags, XML is preferably used for the data exchange for the purpose of processing for utilizing the application of the counterpart device as described above.

Conventionally, if the digital multifunctional device utilizes the application of another device, firmware provided in the digital multifunctional device generates commands written in XML which correspond to the application.

However, for example, if another device which has a new application which is not used conventionally is utilized, the firmware itself must be updated in order to generate XML commands corresponding to the new application. This means that firmware corresponding to new commands must be developed and that processing for updating firmware is needed. Alternatively, if applications are used in a plurality of other devices, a plurality of pieces of firmware must be prepared to change the firmware depending on the application to be used.

For example, Japanese Laid-Open Patent Publication No. 2003-288143 discloses a user interface generator which accesses to a schema file (XSD) to generate a user interface in accordance with a data structure specified in the schema file and which writes data received via the user interface into an XML file. Also, this Japanese Laid-Open Patent Publication No. 2003-288143 discloses a schema editor which can accept user input defining a data structure of an XML file to facilitate the generation of the XML file complying with a certain XSD.

As described above, if the digital multifunctional device utilizes applications of other devices to perform processing of image data, a function for generating XML commands corresponding to other new applications is needed. In order to deal with this, conventionally, processing for updating firmware of the digital multifunctional device or switching over to other firmware is necessary, forcing very inefficient and costly efforts. Also, the conventional approaches prevent quick and simple responses to the diversification of applications and the expansion and complication of network structures.

Further, although Japanese Laid-Open Patent Publication No. 2003-288143 discloses a technology for writing data received by a user interface generator into an XML file and an editor for a schema generating an XML file, it does not disclose a technology obtaining a schema file corresponding to other new applications, and it does not solve a problem associated with the update and switch-over of the firmware of the digital multifunctional device as described above.

### SUMMARY OF THE INVENTION

It is therefore an object of the present invention to provide a digital multifunctional device which can easily generate commands written in XML for utilizing applications in order to easily accommodate to unknown application of the digital multifunctional device if the digital multifunctional device utilizes applications of other devices to perform processing of image data, and to provide a program achieving the functions of the digital multifunctional device, and to provide a recording medium.

Another object of the present invention is to provide an image processing apparatus connected to external devices via communication network, transferring image data to and from the external devices to perform image processing, where the image processing apparatus comprises a schema acquisition portion for obtaining a registered schema corresponding to an application running on an external device from a recording medium recording the schema; a schema registration portion for registering a schema obtained by the schema acquisition portion; a selection portion for selecting a schema used for image processing from schemata registered in the schema registration portion; a commands generation portion for generating commands described in XML using a schema selected by the selection portion; and a commands transmission portion for transmitting commands generated by the commands generation portion to an external device running an application corresponding to the selected schema.

Another object of the present invention is to provide the image processing apparatus where the schema acquisition portion may download and obtains a schema which is registered, along with an application, in the external device via communication network.

Another object of the present invention is to provide the image processing apparatus where the image processing apparatus may comprise a recording medium readout device which can read out data from a predetermined medium, and the schema acquisition portion may obtain a schema read out by the recording medium readout device from a recording medium recording a schema corresponding to a certain application.

Another object of the present invention is to provide the image processing apparatus where the image processing apparatus may comprise a schema edit portion which enables edit of schemata registered in the schema registration portion.

Another object of the present invention is to provide the image processing apparatus where the image processing apparatus may comprise a display portion and an information input screen display portion which generates an information input screen for inputting information needed to generate the commands in accordance with the schema selected by the selection portion and which displays the generated display screen on the display portion, and the commands generation portion may generate the commands based on the information which is input in accordance with the information input screen displayed on the display portion.

Another object of the present invention is to provide the image processing apparatus where the information needed to generate the commands may include any piece or pieces of information of a destination server name, host name or IP address as destination information of the commands; a user name, user ID or password as user information for utilizing an application in a destination; and a directory, file format or image processing method of transmitted image data.

Another object of the present invention is to provide the image processing apparatus where the information input screen display portion may accept designation of information needed to generate the commands depending on the purpose of a user to enable generation of an information input screen in accordance with the designation.

Another object of the present invention is to provide the image processing apparatus where, on the information input screen, the information input screen display portion may accept inputs for deleting input items of unwanted information or inputs for changing information input positions on the screen to enable edit of the information input screen in accordance with the inputs.

Another object of the present invention is to provide the image processing apparatus where the commands transmission portion may transmits commands generated by the commands generation portion to an external device running an application corresponding to the selected schema along with image data to be processed.

Another object of the present invention is to provide the image processing apparatus where the image processing apparatus may be a digital multifunctional device equipped with means for achieving copier, printer, scanner and/or facsimile functions.

Another object of the present invention is to provide a program implementing functions of the processing apparatus as described above.

Another object of the present invention is to provide a recording medium having the above program recorded thereon.

### BRIEF DESCRIPTION OF THE DRAWINGS

The above and other objects, aspects, features and advantages of the present invention will become more apparent from the following detailed description when taken in conjunction with the accompanying drawings, in which:

FIG. 1 is a diagram showing a typical configuration example of a digital multifunctional device;

FIG. 2 is a diagram showing a configuration example of network to which a digital multifunctional device is applied;

FIG. 3 is a diagram for describing a configuration example of network to which an image processing apparatus of the present invention is applied;

FIG. 4 is a diagram for describing functions possessed by a digital multifunctional device and a server connected to the digital multifunctional device via network;

FIG. 5 is a flowchart for describing an example of processing of a digital multifunctional device for obtaining a schema and registering the obtained schema in own storage means;

FIG. 6 is a flowchart for describing an example of processing of a digital multifunctional device for transmitting XML commands to a counterpart device;

FIG. 7 is a flowchart for describing an example of edit processing of a schema recorded in the digital multifunctional device;

FIG. 8 is a diagram showing an example of a basic screen displayed on a display portion of the digital multifunctional device;

FIG. 9 is a diagram showing an example of a schema selection screen displayed when “DATA ENTRY” shown in the basic screen of FIG. 8 is specified;

FIG. 10 is a diagram showing an example of a FAX server selection screen displayed when “FAX SERVER” shown in the basic screen of FIG. 8 is specified;

FIG. 11 is a diagram showing an example of a data input screen generated by a schema;

FIG. 12 is a diagram showing another example of a data input screen generated by a schema;

FIG. 13 is a diagram showing an example of a data structure of a schema registered in the digital multifunctional device; and

FIG. 14 is a diagram showing another example of a data structure of a schema registered in the digital multifunctional device.

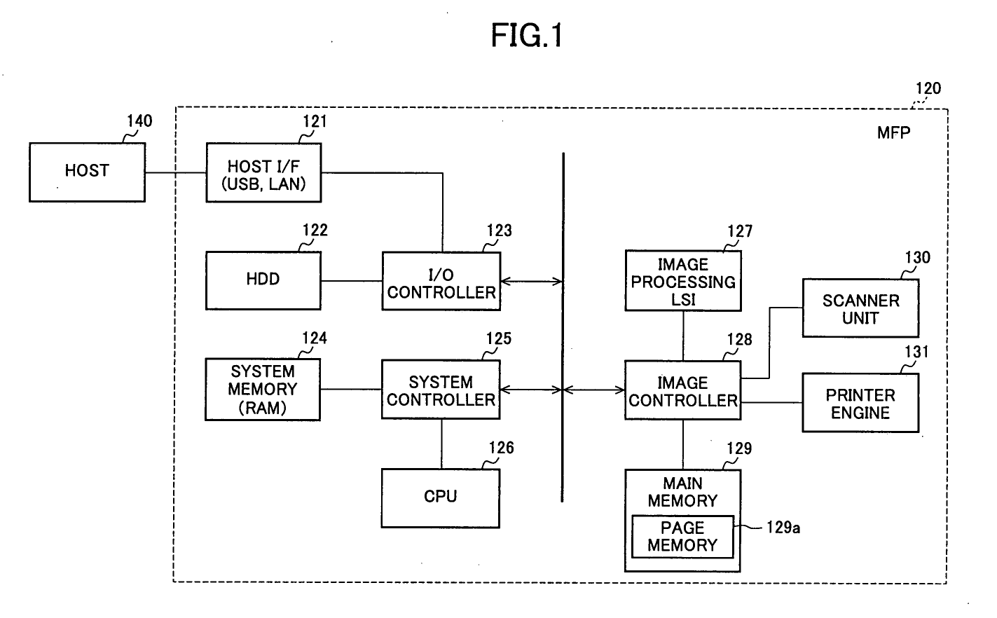

### PREFERRED EMBODIMENTS OF THE INVENTION

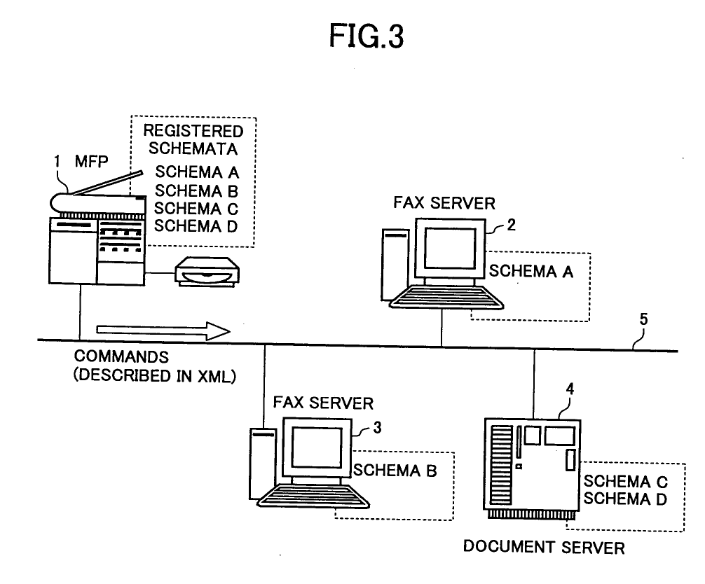

FIG. 3 is a diagram for describing a configuration example of network to which an image processing apparatus of the present invention is applied and in this figure: 1 is a digital multifunctional device (MFP) which is the image processing apparatus of the present invention; 2 is a first FAX server; 3 is a second FAX server; 4 is a document server; and 5 is network.

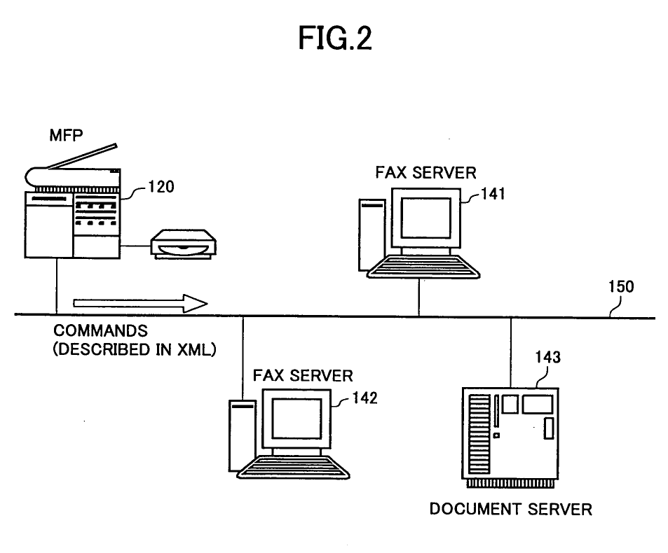

In the example of FIG. 3, as is the case with FIG. 2 described above, the digital multifunctional device 1 is connected to the first and second FAX servers 2, 3 and the document server 4 via the network 5. As described above, if the digital multifunctional device 1 uses the first or second FAX server 2, 3 or the document server 4 to perform processing of image data, commands described in XML (hereinafter, referred to as XML commands) must be transmitted along with the image data obtained by a scanner unit and the like of the digital multifunctional device 1.

In order to generate these XML commands, this embodiment uses the network 5 or a schema obtained from a recording medium such as a card memory. The digital multifunctional device 1 obtains the schema and generates the XML commands from the obtained schema. As described above, the digital multifunctional device 1 can obtain the schema by downloading, via the network 5, a schema registered along with an application in an external device such as a server. Alternatively, the digital multifunctional device 1 can obtain the schema by mounting a recording medium recording the schema corresponding to a certain application into a recording medium readout device provided on the digital multifunctional device 1 and reading the schema from the recording medium.

Then, the generated XML commands are transmitted to an intended counterpart device (such as the first and second FAX servers 2, 3, or the document server 4) to perform the processing of the image data, using the application of the counterpart device.

For example, in the example of FIG. 3, the first FAX server 2 has an application for achieving the functions of the server 2 and a schema corresponding to that application (referred to as schema A). Similarly, the second FAX server 3 has an application for achieving the functions of the server 3 and a schema corresponding to that application (referred to as schema B). Also, the document server 4 has applications for achieving the functions of the server 4 and schemata, each of which corresponds to each of these application (referred to as schema C, D).

Although one application may correspond to a plurality of schemata, in either case, the association is determined for correspondence between the schema and the application.

In order to utilize these applications of the counterpart devices to perform the processing of the image data, the digital multifunctional device 1 obtains, via the network 5, a schema possessed by each counterpart device. In the example of FIG. 3, the digital multifunctional device 1 can obtain the schema from each of the first and second FAX servers 2, 3 and the document server 4 to record and retain the obtained schemata A to D into the own storage means (memory and the like).

If the digital multifunctional device 1 utilizes the application of each counterpart device to perform processing of the image data, the digital multifunctional device 1 selects a schema corresponding to the application of the counterpart device from the schemata retained in the own storage means, generates a UI (user interface) screen, which depends on the schema, by the selected schema, and uses input data to be input in accordance with the UI by a user to generate XML commands defined by the schema.

The generated XML commands are transmitted to the appropriate counterpart device along with the image data to be processed. The application of the counterpart device performs predetermined processing for the image data in accordance with the transmitted XML commands. If the XML commands and the image data to be processed are associated with each other, the XML commands and the image data may be transmitted separately to the counterpart device, although the XML commands are basically transmitted along with the image data.

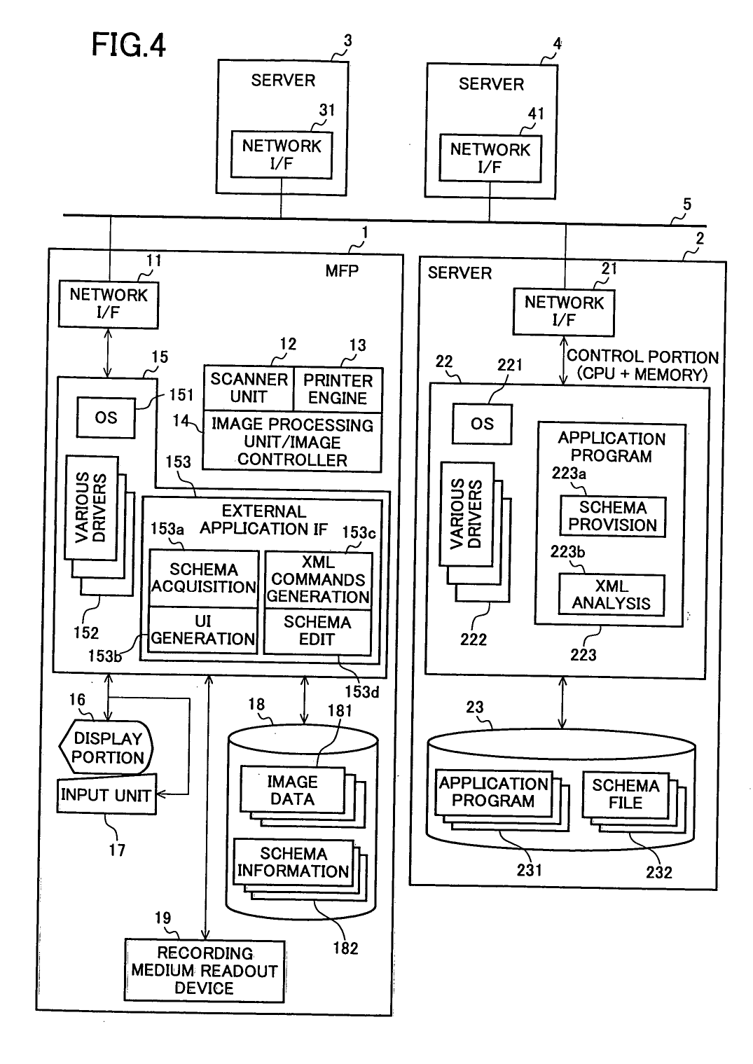

FIG. 4 is a diagram for describing functions possessed by the digital multifunctional device having the functions as described above and the server connected to the digital multifunctional device via network. The digital multifunctional device 1 is connected to the network 5 (LAN in this figure) via a network I/F 11 and has a control portion 15 having a CPU and memory, a scanner unit 12, a printer engine 13, an image processing unit/image controller 14 and the like. The control portion 15 retains an OS 151, various drivers 152 and the like as well as an external application IF program 153 of the present invention.

The external application IF program 153 achieves functions of a schema acquisition portion 153a obtaining schemata via the network and the like, a UI (user interface) generation portion 153b generating a UI having an information input screen from the obtained schema, an XML commands generation portion 153c generating XML commands in accordance with item information which is input by a user using the generated UI, and a schema edit portion 153d enabling edit of the retained schemata.

Also, the digital multifunctional device 1 has a display portion 16 using a liquid-crystal panel and the like, an input unit 17, such as a keyboard, mouse, touch panel, pen-based input device and the like, enabling various input operations of the user, and a recording medium readout device 19 into which a recording medium can be inserted and which reads data from the recording medium.

Further, a storage portion 18 such as a HDD retains image data 181 and schema information 182. The image data 181 is document image data input from the scanner unit 12, image data read out from the recording medium readout device 19 or image data input from the network or other interfaces. When transmitted to external devices using applications of the external devices, XML commands generated by the XML commands generation portion 153c are attached to the image data 181. The schema information 182 is the schemata obtained by the schema acquisition portion 153a from the network 5 or the recording medium readout device 19.

The server 2 is connected to the network 5 via a network I/F 21 and equipped with a control portion 22 having a CPU and memory, application programs 231 achieving functions of the server, and a storage portion 23 retaining schema files 232, each of which corresponds to each of these application programs 231. The control portion 22 retains an OS 221, various drivers 222, and a schema provision/command analysis application program 223 which achieves functions of a schema provision portion 223a and an XML analysis portion 223b of the present invention, where the XML analysis portion 223b analyzes the received XML commands. The schema provision portion 223a transmits schema files, which are to be retained, to the storage portion 23 upon requests from the digital multifunctional device 1. Also, in some environments, the schema file may be transmitted to the certain digital multifunctional device 1 from the server side by the push forwarding.

The XML analysis portion 223b analyzes the XML commands transmitted along with the image data from the digital multifunctional device 1. The application program 231 is operated in accordance with the result of the analysis to perform predetermined processing in accordance with the above commands.

At this point, the application operated by the XML commands transmitted from the digital multifunctional device corresponds to the application program 231 stored in the storage portion 23.

In addition to this, the network 5 may be connected with other servers 3, 4, and these servers 3, 4 are provided with the same functions as the server 2 in order that the digital multifunctional device 1 utilizes applications thereof.

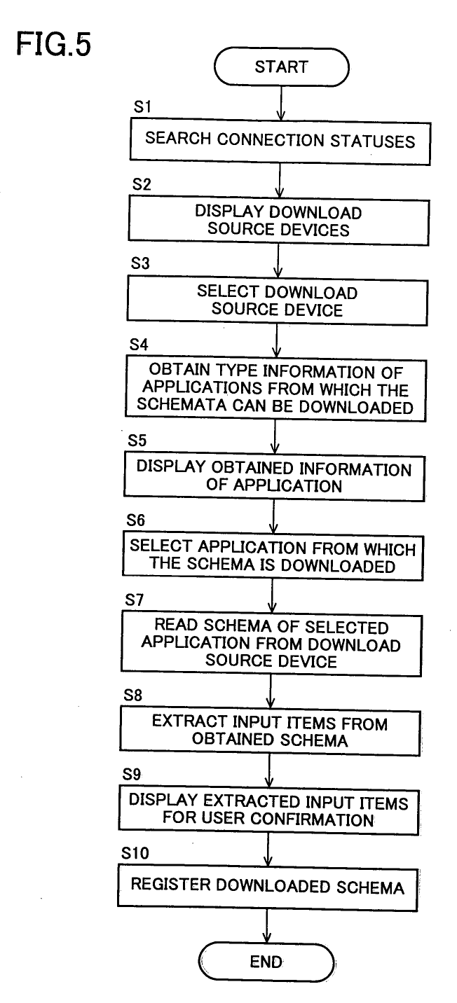

FIG. 5 is a flowchart for describing an example of processing of the digital multifunctional device 1 for obtaining a schema and registering the obtained schema in own storage means as described above. In this registration processing, with the configuration of FIG. 4, the schema acquisition portion 153a of the external application IF program 153 functions to perform the acquisition and registration of a schema.

First, the digital multifunctional device 1 searches connection statuses of download source devices from which the schemata are downloaded (step S1) and displays the searched devices on the display portion 16 thereof (step S2). At this point, as the download source devices of the schemata, the search is performed for not only other devices connected via the network (for example, the first and second FAX servers 2, 3 and the document server 4 shown in FIG. 3) and the like, but also the recording medium readout device 19 which can read out the recording medium storing the schemata, and the like.

From the searched devices, a device is selected as a download source of a schema (step S3). Although this selection is performed in accordance with the input from the user, the digital multifunctional device 1 may determine a device on the network or the like having an application which does not retain any schema or where the schema is changed (updated), and may automatically select an device from which a schema is to be downloaded in accordance with the result of the determination.

Subsequently, type information is obtained for the applications (the applications corresponding to the schemata which can be downloaded) from which the schemata can be downloaded (step S4), and obtained information of those applications is displayed on the display portion 16 of the digital multifunctional device 1 (step S5). Then, the selection is made for the application from which the schema is to be downloaded (step S6). Although this selection of application is performed in accordance with the input from the user, the digital multifunctional device 1 may determine an application which does not retain any schema or where the schema is changed (updated), and may automatically select an application from which a schema is to be downloaded in accordance with the result of the determination.

Then, the schema of the application selected in step S6 is read from the download source device selected in step S3 (step S7).

In step S6 described above, although by selecting the application, the schema corresponding to the selected application will be selected, the selection of the application here has the same meaning as selecting the schema, and the appropriate schema is obtained by the digital multifunctional device 1 in accordance with the result of the selection.

Then, the digital multifunctional device 1 extracts input items from the obtained schema (step S8). The input items are information items necessary for generating XML commands and indicate items where data are input by a user.

The input items may be: a counterpart server name, host name, IP address and the like for destination information of the XML commands; a user name, user ID, password and the like for information of the user generating the XML commands to utilize the application of the counterpart; and a directory, file format, image processing method and the like of the transmitted image data. When information appropriate for the input items is input from the user, the schema can generate the XML commands by using the input information.

After the input items are extracted in the above step S8, the input items are displayed on the display portion 16 of the digital multifunctional device 1 to allow the user to confirm the items (step S9). At this point, in this registration processing, the user may be prompted to input data corresponding to the input items or may be prompted to input data for the input items when the XML commands are generated. Also, the input items may be specified depending on the purpose of the user, and the display portion 16 may display an input screen in accordance with the specified input items. Further, the display of the input items on the display portion 16 may be editable. For example, input items for unwanted information can be deleted, and input positions for the input items on the screen can be changed.

Then, the downloaded schema is registered in the storage portion 18 of the digital multifunctional device 1 as the schema information 182 (step S10). At this point, related information is also registered, such as a name of an application corresponding to the schema and a name of a server running the application. The processing at the time of the XML registration is terminated by above operations.

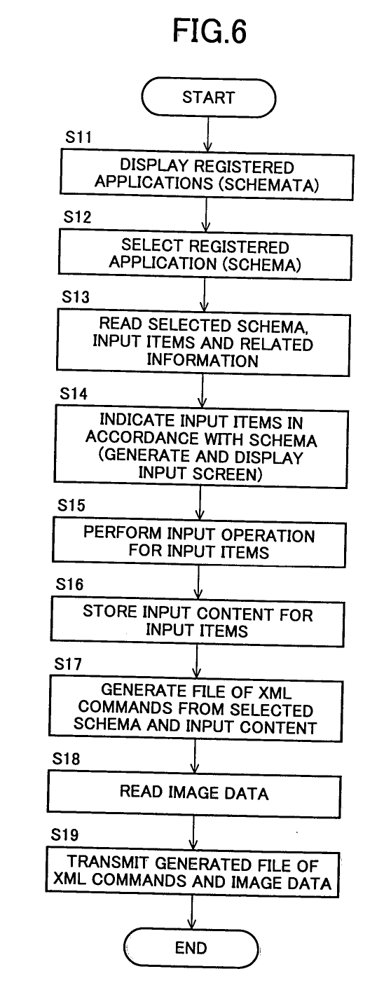

FIG. 6 is a flowchart for describing an example of processing of the digital multifunctional device for transmitting XML commands to a counterpart device. For this XML commands transmission processing, in the configuration of FIG. 4, the UI generation portion 153b and the XML commands generation portion 153c of the external application IF program 153 perform functions for generating a UI (input screen) in accordance with the schema and for generating and transmitting XML commands in accordance with input data.

In FIG. 6, first, the display portion of the digital multifunctional device 1 displays applications corresponding to the schemata registered in the digital multifunctional device 1 (step S11). Then, from the displayed applications, an application is selected for utilizing with XML commands (step S12). Although the selection of the application is performed in accordance with the input from the user, the appropriate application may be automatically selected by determining a counterpart device.

In the steps S11 and S12, by displaying applications and selecting an application from displayed the applications, a schema corresponding to that application is selected as a result. Therefore, at this point, by displaying information for identifying schemata registered in the digital multifunctional device, a schema may be directly selected from the information.

Then, the digital multifunctional device 1 reads, from the storage portion 18, a descriptive content of the schema corresponding to the selected application, the input items as described above and the related information (for example, the name of the server as the counterpart device, and the name of the application) (step S13), and generates an input screen showing input items which depend on the schema to display the input screen on the display portion 16 (Step S14).

When the user performs input operations for the input items on the input screen displayed on the display portion 16 (step S15), the digital multifunctional device 1 stores the input content of the input items (step S16). Then, a file of XML commands is generated from the selected schema and the input content of the input items (step S17).

Then, the digital multifunctional device 1 reads image data to be processed (step S18). In this case, the image data can be read using the scanner unit 12 of the digital multifunctional device 1 as described above and may be read from a recording medium or an external recording device recording the image data in advance.

Subsequently, the file of the XML commands generated in the above step S18 and the read image data are transmitted to another device which is a target (for example, a server) (step S19).

In this way, by receiving the file of the XML commands generated in the digital multifunctional device 1 with a server and the like, the server analyzes the XML commands and performs predetermined processing using an image processing application program in accordance with the analysis result.

The schema downloaded to the digital multifunctional device 1 can be edited. For example, by editing and transmitting the schema to the server as the counterpart device, the processing corresponding to the edited schema can also be performed on the server side. In this case, the server receiving the edited schema must have a function for retrieving and reflecting the edited content.

The editing can be performed for adding input options which can be selected as parameters of the XML commands (for example, adding a new method to image compression methods, or adding a new method such as a mail or FTP which is not included in selection types of destinations) or can be performed for adding a new parameter itself.

The XML command is in accordance with a schema which is a descriptive grammar, and although the input information which is input by the user from the input screen may be entered as parameters in the XML commands, no other editing will be performed.

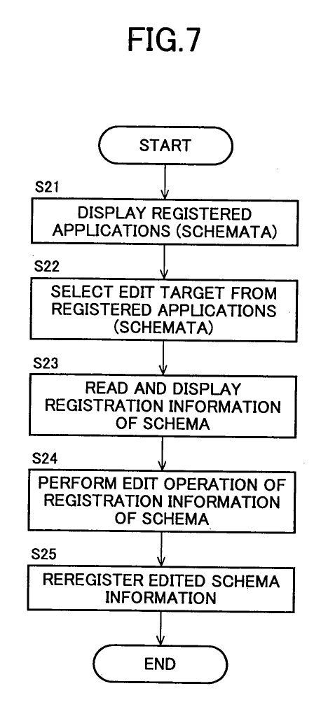

FIG. 7 is a flowchart for describing an example of edit processing of a schema recorded in the digital multifunctional device. In this editing processing, with the configuration of the FIG. 4, the schema edit portion 153d of the external application IF program 153 performs functions for enabling schema editing.

As described above, the schema can be edited. If the schema registered in the digital multifunctional device is edited, first, the display portion 16 displays applications for which schemata are registered in the storage portion 18 of the digital multifunctional device 1 (step S21). Then, from the applications displayed on the display portion 16, an application having a schema to be edited (step S22) is selected. This selection is performed in accordance with the input from the user.

In the above steps S21 and S22, by displaying applications and selecting an application from the displayed applications, a schema corresponding to that application is selected as a result. Therefore, at this point, by displaying information for identifying schemata registered in the digital multifunctional device, a schema may be directly selected from the schemata.

Then, the digital multifunctional device 1 reads he registration information of the schema corresponding to the selected application (a descriptive content of the schema and related information such as a server name and an application name, and the like) and displays the registration information on the display portion 16 (step S23).

Then, for the displayed registration information of the schema, editing by the user is accepted. The user can perform any editing by inputting editing operations while viewing the display screen (step S24).

After the editing is completed, the edited schema information is registered again as the schema information 182 in the storage portion 18 of the digital multifunctional device 1 (step S25).

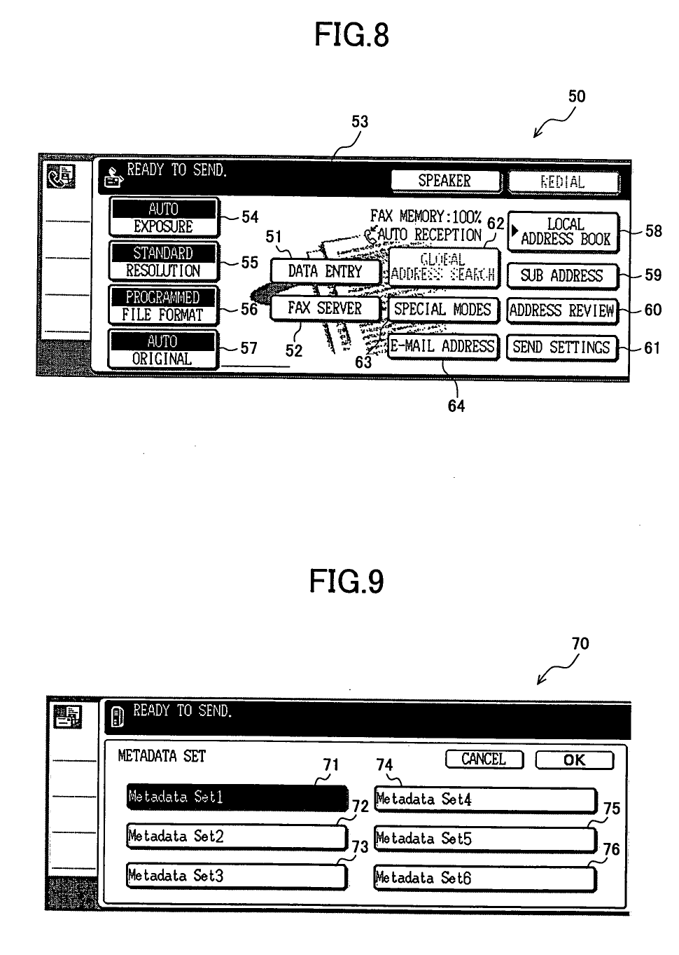

Now, an example is shown for the display screen of the display portion 16 of the digital multifunctional device 1 having the functions described above. FIG. 8 is a diagram showing an example of a basic screen displayed on a display portion of a digital multifunctional device. On this screen, by performing operations for selecting “DATA ENTRY” 51 or “FAX SERVER” 52 displayed on the basic screen 50, the user can proceed to a screen for selecting an application or a schema.

In addition to this, the example of FIG. 8 is set up with “READY TO SEND” 53, “AUTO EXPOSURE” 54, “STANDARD RESOLUTION” 55 and “AUTO ORIGINAL” 57, and further set up with “LOCAL ADDRESS BOOK” 58, “SUB ADDRESS” 59, “ADDRESS REVIEW” 60, “SEND SETTINGS” 61, “GLOBAL ADDRESS SEARCH” 62, “SPECIAL MODES” 63 and “E-MAIL ADDRESS” 64. Since these are general functions which are not relevant to the generation of the XML commands of the present invention, descriptions thereof are omitted.

FIG. 9 is a diagram showing an example of a schema selection screen displayed when the “DATA ENTRY” 51 shown in the basic screen 50 of FIG. 8 is specified. The “DATA ENTRY” 51 is used, for example, when image data is transmitted from the digital multifunctional device 1 to the document server 4 and when the image data is retained by the document server. A screen 70 of FIG. 9 is a schema selection screen and is displayed as a screen enabling identification of schemata to which “Metadata Set 1” 71 to “Metadata Set 6” 76 are registered.

The Metadata indicate metadata of input items of schemata and by selecting any one of the Metadata Sets, a certain schema can be selected from the registered schemata. By selecting the XML schema, an application corresponding to that schema is selected.

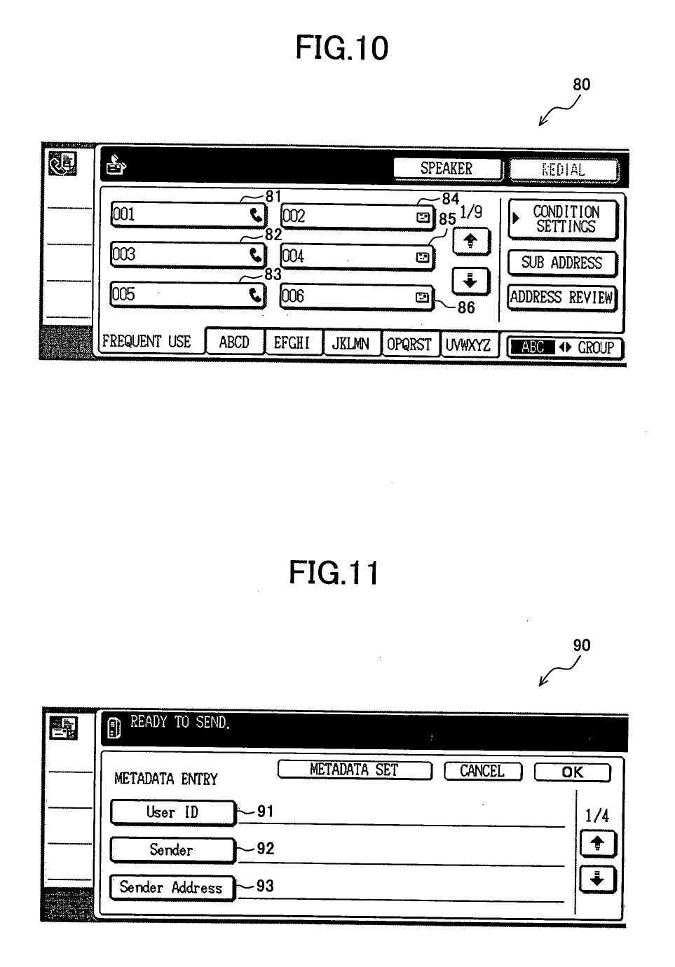

FIG. 10 is a diagram showing an example of a FAX server selection screen displayed when the “FAX SERVER” 52 shown in the basic screen 50 of FIG. 8 is specified. The “FAX SERVER” 52 is used when a plurality of FAX servers are connected to the digital multifunctional device 1 and when image data is transmitted to the FAX server, for example, to perform processing of the image data for facsimile transmission to a specified destination.

A screen 80 of FIG. 10 is a FAX server selection screen and displays “001” 81 to “006” 86 as identification information for the FAX servers. Each number can identify the registered FAX server (in this example, nine FAX servers are registered in total). By selecting any one from the FAX server identification information, a schema corresponding to the selected FAX server (i.e., a schema corresponding to the application used in the FAX server) can be selected.

In the example of FIG. 9, by selecting a metadata set, a certain schema is selected from the registered schemata. In the example of FIG. 10, by selecting a counterpart device, a schema which is registered and associated with the device is selected.

From the selected schema, an input screen for data input from a user is generated as a UI and is displayed on the display portion 16 of the digital multifunctional device 1.

FIG. 11 is a diagram showing an example of a data input screen generated from a schema. A screen 90 of FIG. 11 displays “User ID” 91, “Sender” 92 and “Sender Address” 93 as input items. These input items are configured in accordance with the selected schema and a user performs data input for the input items. The input data may be data for an individual user incorporated into the schema or may be user data included in the XML commands. As described above, the data input screen may display input items which is specified depending on the purpose of the users or can be edited by deleting displayed input items or by changing display positions of the input items.

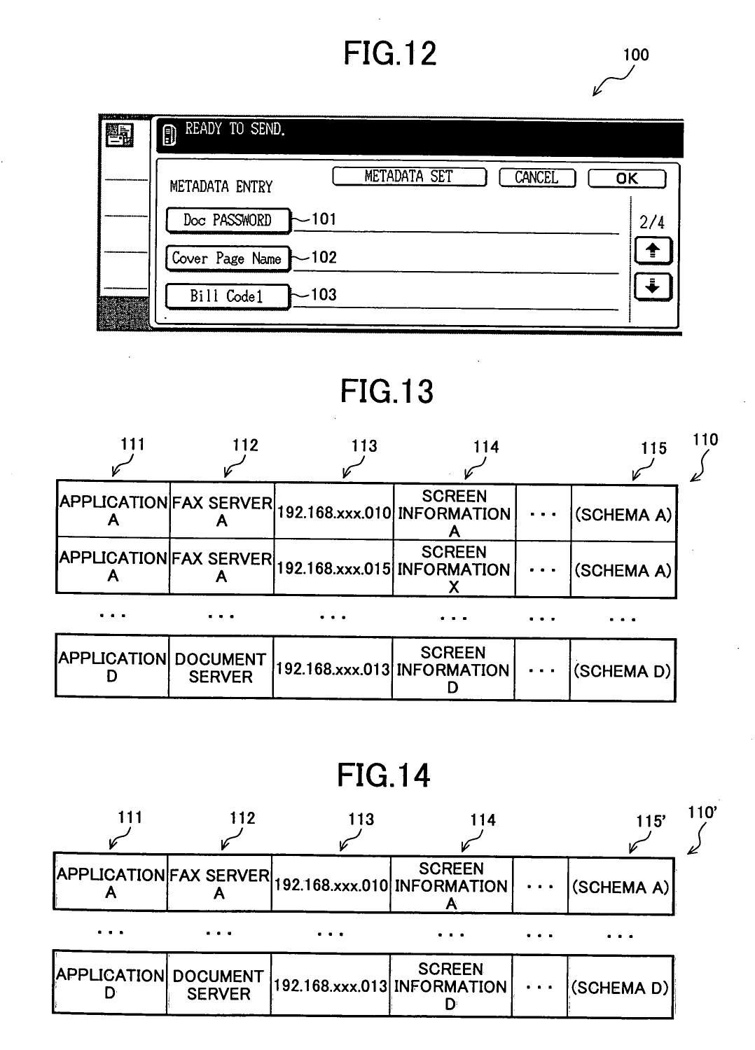

FIG. 12 is a diagram showing another example of a data input screen generated from a schema. A screen 100 of FIG. 12 is generated from a schema different from a schema generating the screen 90 of FIG. 11 and displays “Doc PASSWORD” 101 for a document password, “Cover Page Name” 102 for the name of a cover page and “Bill Code1” 103 for a bill coed as input items. This schema is an example which is defined in order to transmit image data to a billing system.

A user inputs data in accordance with the input items displayed in the same way.

In this way, the digital multifunctional device 1 generates and displays an input screen in accordance with the selected schema, retrieves the input data which is input depending on the input items of the displayed screen, generates XML commands and transmits the XML commands along with image data to be processed to a specified destination. The destination device analyzes the XML commands and can perform processing of the image data in accordance with the analysis result.

FIG. 13 is a diagram showing an example of a data structure of the schema registered in the digital multifunctional device. The data structure 110 of each schema includes an application name 111 which is identification information of an application, a name 112 of a server running the application corresponding to the schema, an IP address 113 of the server, an input item display screen ID 114 and schema data 115. Although an input display screen is generated in accordance with the descriptive data of the schema, the input display screen can have the display screen ID 114 specifying a structure of a display screen.

FIG. 14 is a diagram showing another example of a data structure of a schema registered in the digital multifunctional device. The example of a schema structure 110′ of FIG. 14 includes pointer information 115′ for the schema data, instead of the schema data 115 of FIG. 13. In other words, in some cases, even if the schema data is not included in the registration data, an appropriate schema may be used with the pointer information 115′ for the schema data.

Although, in above examples, the embodiments of the image processing apparatus of the present invention is described by taking the digital multifunctional device as an example, the present invention is not limited to the digital multifunctional device 1 and has possibility for applying the present invention to a network device which performs processing in conjunction with another device connected to network.

The programs according to the present invention are programs controlling a CPU and the like of a computer as means (or a portion of means) for achieving the functions of the embodiments described above (programs forcing a computer to perform functions). Information handled by the image processing apparatus is temporarily accumulated in a RAM or the like at the time of processing and then stored into various ROMs or hard disks, and reading, modification or writing of the information is performed, if desired.

The programs for achieving the above functions are, for example, stored in a recording medium such as a CD-ROM in advance, and the functions of the present invention can be achieved by loading the recording medium into a medium drive device such as a CD-ROM drive provided in the computer and the like, by storing the programs into a memory of the computer or a recording device, and by executing them. In this case, the functions of the embodiments described above are achieved by the programs itself read from the recording medium, and the programs and the recording medium recording the programs also constitute the present invention.

The recording medium storing the programs may be any of a semiconductor medium (e.g., a ROM, nonvolatile memory card and others), an optical recording medium (e.g., a DVD, MO, MD, CD and others), a magnetic recording medium (e.g., a magnetic tape, flexible disk and others) and the like.

Not only the functions of the embodiments described above are achieved by executing the loaded program, but also the functions of the embodiments described above may be achieved by performing processing in conjunction with an operating system or other application programs based on instructions from the loaded programs.

When distributing to the market, the programs can be stored into a portable recording medium for distribution or can be transferred to server computers connected via network, such as the internet. In this case, the recording medium of the present invention includes a storage device of the server computer.

In a computer, the functions of the embodiments described above are achieved by installing the programs on the portable recording medium or the transferred programs into the recording medium connected to the computer and by executing the installed programs.

According to the present invention, following advantages can be obtained.

According to the present invention, if the digital multifunctional device utilizes applications of other devices to perform processing of the image data, commands corresponding to the application to be utilized can be generated easily by obtaining and using a schema for generating the commands, and thereby, firmware is not needed to be updated or switched depending on the applications, therefore more convenience can be offered to users.

While the illustrative and presently preferred embodiments of the present invention have been described in detail herein, it is to be understood that the inventive concepts may be otherwise variously embodied and employed and that the appended claims are intended to be construed to include such variations except insofar as limited by the prior art.

1. An image processing apparatus connected to external devices via communication network, transferring image data to and from the external devices to perform image processing, the image processing apparatus comprising:
a schema acquisition portion for obtaining a registered schema corresponding to an application running on an external device from a recording medium recording the schema;
a schema registration portion for registering a schema obtained by the schema acquisition portion;
a selection portion for selecting a schema used for image processing from schemata registered in the schema registration portion;
a commands generation portion for generating commands described in XML using a schema selected by the selection portion; and
a commands transmission portion for transmitting commands generated by the commands generation portion to an external device running an application corresponding to the selected schema.

2. The image processing apparatus of claim 1, wherein the schema acquisition portion downloads and obtains a schema which is registered, along with an application, in the external device via communication network.

3. The image processing apparatus of claim 1, wherein the image processing apparatus has a recording medium readout device which can read out data from a predetermined medium, and
wherein the schema acquisition portion obtains a schema read out by the recording medium readout device from a recording medium recording a schema corresponding to a certain application.

4. The image processing apparatus of claim 1, comprising a schema edit portion which enables edit of schemata registered in the schema registration portion.

5. The image processing apparatus of claim 1, wherein the image processing apparatus has a display portion and an information input screen display portion which generates an information input screen for inputting information needed to generate the commands in accordance with the schema selected by the selection portion and which displays the generated display screen on the display portion, and
wherein the commands generation portion generates the commands based on the information which is input in accordance with the information input screen displayed on the display portion.

6. The image processing apparatus of claim 5, wherein the information needed to generate the commands includes any piece or pieces of information of:
a destination server name, host name or IP address as destination information of the commands;
a user name, user ID or password as user information for utilizing an application in a destination; and
a directory, file format or image processing method of transmitted image data.

7. The image processing apparatus of claim 5, wherein the information input screen display portion accepts designation of information needed to generate the commands depending on the purpose of a user to enable generation of an information input screen in accordance with the designation.

8. The image processing apparatus of claim 5, wherein, on the information input screen, the information input screen display portion accepts inputs for deleting input items of unwanted information or inputs for changing information input positions on the screen to enable edit of the information input screen in accordance with the inputs.

9. The image processing apparatus of claim 1, wherein the commands transmission portion transmits commands generated by the commands generation portion to an external device running an application corresponding to the selected schema along with image data to be processed.

10. The image processing apparatus of claim 1, wherein the image processing apparatus is a digital multifunctional device equipped with means for achieving copier, printer, scanner and/or facsimile functions.

11. A program implementing a function of the image processing apparatus of claim 1.

12. A recording medium having thereon recorded the program of claim 11.
